(19) United States
(12) Patent Application Publication
(10) Pub. No.: US 2025/0078509 A1
(43) Pub. Date: Mar. 6, 2025

(54) GENERATION OF THEME BLOCKS FOR VIDEO

(71) Applicant: Hewlett-Packard Development Company, L.P., Spring, TX (US)

(72) Inventors: Guillaume Gerardin, Boise, ID (US); Gabriel Scott McDaniel, Boise, ID (US); Ella Brucker, Boise, ID (US); Elizabeth Swanson, Boise, ID (US); Jeffrey Luke, Boise, ID (US); Paul L. Jeran, Boise, ID (US)

(21) Appl. No.: 18/238,866

(22) Filed: Aug. 28, 2023

(51) Int. Cl. G06V 20/40; G06T 7/70; G10L 15/26

(52) U.S. Cl. CPC G06V 20/49; G06T 7/70; G06V 20/41; G06V 20/47; G10L 15/26; G06V 2201/07

(57) ABSTRACT

A video is divided into video segments, and each video segment is divided into one or more video sub-segments. A theme of each video segment is identified using machine learning. Theme blocks for the video are generated such that each theme block corresponds to one or more of the video sub-segments having a common theme.

### BACKGROUND

Traditionally, electronic information has been static, in the form of text and images. The static nature of the electronic information permitted users to easily print hardcopies using printing devices. However, electronic information is now often dynamic, such as in the form of video. For example, users may participate in video conferences and electronic meetings, which may be recorded for later viewing. Video recorded professionally as well as by amateurs has also become a popular way to disseminate information, such as via video-sharing platforms.

### BRIEF DESCRIPTION OF THE DRAWINGS

FIG. 1 is a diagram of an example process for generating theme blocks for a video.

FIG. 2A is a diagram of example division of a video into segments, which can implement part of the process of FIG. 1.

FIG. 2B is a diagram of example division of a video segment into sub-segments, which can implement part of the process of FIG. 1.

FIG. 3A is a diagram of an example process for identifying a theme of a video sub-segment, which can implement part of the process of FIG. 1.

FIGS. 3B and 3C are diagrams of example contextual attributes of a video sub-segment that can be extracted and used in the process of FIG. 3A.

FIG. 4A is a diagram of an example process for generating theme blocks from video sub-segments and their associated themes, which can implement a part of the process of FIG. 1.

FIG. 4B is a flowchart of an example method for iteratively merging candidate theme blocks together, which can implement part of the process of FIG. 4A.

FIGS. 4C and 4D are flowcharts of an example method for iteratively deduplicating candidate theme blocks, which can implement part of the process of FIG. 4A.

FIG. 4E is a flowchart of an example method for removing less relevant candidate theme blocks, which can implement part of the process of FIG. 4A.

FIG. 5 is a diagram of an example summarization of a video, including individual summarizations of theme blocks of the video.

FIG. 6 is a diagram of an example non-transitory computer-readable data storage medium storing program code for generating theme blocks for a video, and is consistent with the process of FIG. 1.

FIG. 7 is a diagram of an example computing device for generating theme blocks for a video, and is consistent with the process of FIG. 1.

FIG. 8 is a flowchart of an example method for generating theme blocks for a video, and is consistent with the process of FIG. 1.

### DETAILED DESCRIPTION

As noted in the background, electronic information is often dynamic, such as in the form of video. Such video can include recorded live presentations and video conferences, and video that is professionally recorded or recorded by amateurs for dissemination without prior live presentation or participation. Video often includes facial images of presenters, as well as other users such as audience members and video conference participants. In comparison with static forms of electronic information, video and other types of dynamic electronic information are more difficult to print hardcopies of. A user wishing to quickly review a video to discern the information contained therein may have to skip through the video, which may result in the user missing key information, or have to play back the video at a fast playback speed, which can be difficult to understand, and requires additional time and effort.

Therefore, a summarization may be generated for a video in which there are individual summarizations for different theme blocks of the video that correspond to different topics. Each theme block includes a contiguous set of frames of the video in which a corresponding topic is being discussed or presented. Not all the frames of the video may be categorized in a theme block. That is, the theme blocks may themselves be discontiguous. For each theme block, text summarizing the theme block may be generated and displayed within the summarization of the theme block, along with a representative frame of the video for the theme block. The summarization itself is in non-video form, such as a static document having one or more multiple pages, lending itself to more convenient review by users to discern the information contained in the video without viewing the video itself. Hardcopies of the non-video summarization may be printed, for instance.

Video summarization techniques may require a user to manually identify the theme blocks of a video, even if the techniques are able to select a representative frame for each theme block and generate text summarizing each theme block automatically. Techniques that automatically identify, or generate, the theme blocks of a video without user involvement are a type of image processing that requires the utilization of computers and do not merely automate what users can perform themselves. That is, while a user may be able to manually identify the theme blocks of a video that correspond to different topics presented in the video, automatic techniques do not automate the manual identification process that the user performs, but rather generate the theme blocks in a different way.

Such automatic techniques cannot be performed by a user manually, because the type of image processing that they perform, which may leverage machine learning, are intractable without the utilization of a computer. Stated another way, theme block generation techniques are necessarily a computing-oriented technology. Such techniques that identify the theme blocks of a video that are more indicative of the content of the video constitute a technological improvement. To the extent that the techniques employ image processing and/or machine learning, the techniques do not use such processing and/or machine learning in furtherance of an abstract idea, but rather to provide a practical application, namely the improvement of an underlying technology.

Described herein are techniques for generating theme blocks of a video that are more indicative of the content contained within the video (e.g., that are more indicative of the topics discussed within the video) and that are better able to divide the frames of the video over these theme blocks, as compared to existing techniques. The techniques leverage image processing and machine learning to generate the blocks for a video, such that their manual performance-without the utilization of computers—is intractable. The techniques accurately identify the topics presented in the video, and the portion of the video (i.e., the theme block) in which each topic is presented.

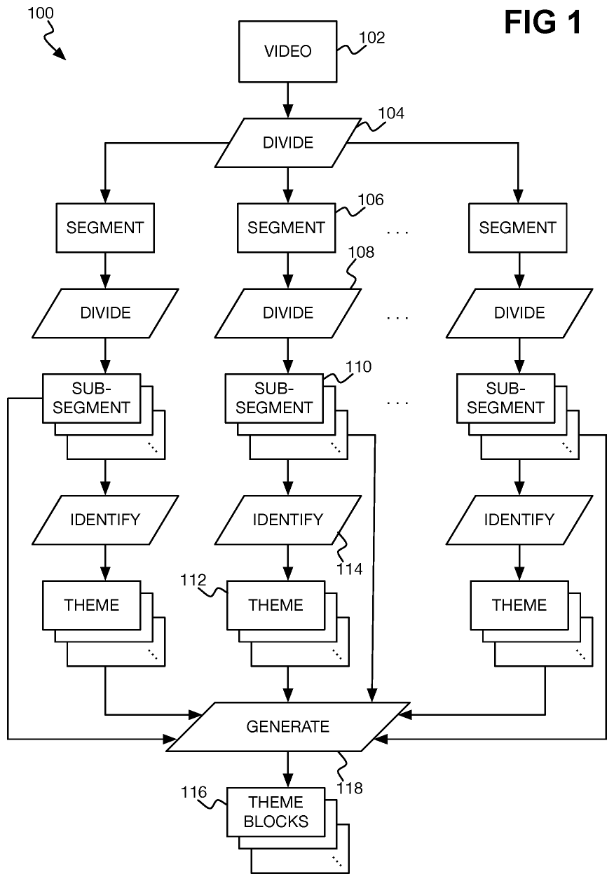

FIG. 1 illustratively depicts an example process for generating theme blocks 116 of a video 102. The video 102 is initially divided (104) into video segments 106, where each segment 106 includes multiple contiguous frames of the video 102. The video segments 106 may be contiguously adjacent, such that from the first frame of the video 102 to the last frame, the frames are segmented into contiguous segments 106. Each segment 106 is then divided (108) into video sub-segments 110, where each sub-segment 110 includes multiple contiguous frames of a segment 106. The video sub-segments 110 of a segment 106 may also be contiguously adjacent, such that from the first frame of the segment 106 to the last frame, the frames are segmented into contiguous sub-segments 110. Example techniques for dividing the video 102 into segments 106, and example techniques for dividing each segment 106 into sub-segments 110, are described later in the detailed description.

Themes 112 of the sub-segments 110 are respectively identified (114). Each sub-segment 110 of each segment 106 of the video 102 thus has a corresponding theme 112, which is the topic being presented or discussed in that sub-segment 110. Theme blocks 116 of the video 102 are then generated (118) based on the themes 112 of the sub-segments 110, where each theme block 116 includes or corresponds to one or more contiguous sub-segments 110 that have a common theme 112. Example techniques for identifying the theme 112 of a video sub-segment 110, and example techniques for generating the theme blocks 116 of the video 102 from the sub-segments 110 and their respective themes 112, are described later in the detailed description.

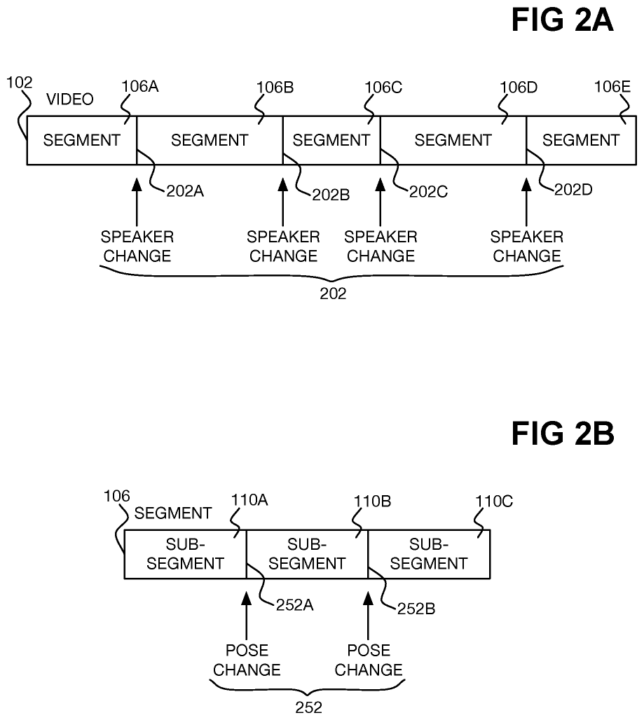

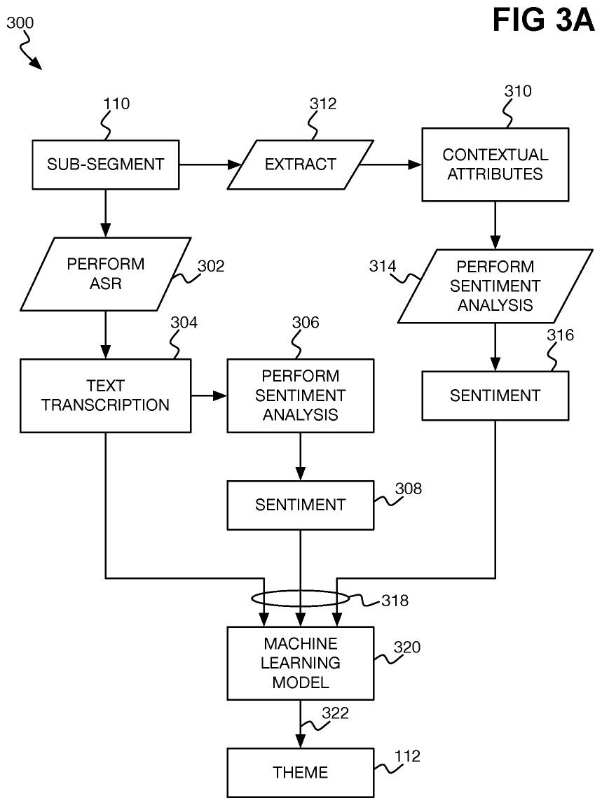

FIG. 2A illustratively depicts an example of how the video 102 can be divided into video segments 106 using speaker diarization. Speaker diarization identifies when the person in the video 102 who is currently speaking changes, and can be performed by applying a speaker diarization technique to the video 102. Example software diarization techniques include that provided by the LIUM_SpkDiarization software tool, which is described at the web site projets-lium.univ-lemans.fr/spkdiarization/, and the speaker diarization capability of the Google Cloud Speech-to-Text platform as described at cloud.google.com/speech-to-text/docs/multiple-voices.

In the example, there are four speaker changes 202A, 202B, 202C, and 202D, which are collectively referred to as the speaker changes 202. Each speaker change 202 corresponds to the boundary between adjacent video segments 106, such that the video 102 is divided into segments 106 in accordance with the speaker changes 202. In the example, therefore, there are five segments 106A, 106B, 106C, 106D, and 106E. It is noted that the same person may be the speaker in multiple discontiguous segments 106. For example, a first user may be the speaker in segment 106A, a second user may be the speaker in segment 106B, and then the first user may again be the speaker in segment 106C.

FIG. 2B illustratively depicts an example of how a video segment 106 can be divided into video sub-segments 110 using pose detection. Pose detection generally detects a position and orientation of an object in a video, and therefore in the context of FIG. 2B detects the position and orientation of the speaker of the video segment 106 throughout the segment 106. Pose detection is performed by applying a pose detection technique to the video segment 106. As an example, the TensorFlow open source machine learning platform has pose detection capability as described at the web sitewww.tensorflow.org/lite/examples/pose_estimation/overview. Other example pose detection techniques include those provided by the OpenPose system available at github.com/CMU-Perceptual-Computing-Lab/openpose, and the PoseNet model available at github.com/tensorflow/tfjs-models/tree/master/posenet.

In the example, there are two pose changes (i.e., changes in position and orientation of the speaker) 252A and 252B in the video segment 106, which are collectively referred to as the pose changes 252. The segment 106 is divided into sub-segments 110 in accordance with the pose changes 252. In the example, therefore, there are three sub-segments 110A, 110B, and 110C. The pose detection software tool may identify the pose of the speaker for each frame (or for each group of a number of frames) of the segment 106, such that a pose change 252 is identified each time the pose changes between adjacent frames (or between adjacent frame groups) by more than a threshold.

The pose detection software tool may permit the input of the object (e.g., which person) in the video segment 106 the tool should identify the pose of. In such an example, the person who is speaking in the video segment 106 is provided to the tool, and the tool provides the pose of just this person. The pose detection software tool may instead identify the pose of every object in the video segment 106. In this case, just the pose of the person who is speaking in the video segment 106 is used for dividing the segment 106 into sub-segments 110, and not the poses of other persons or objects.

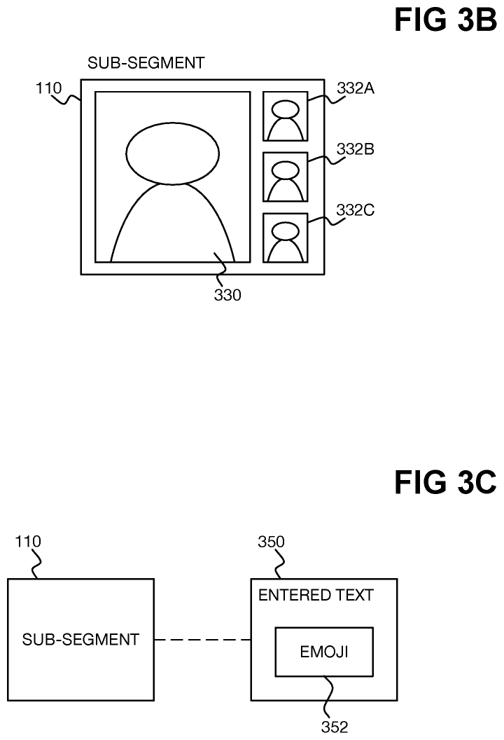

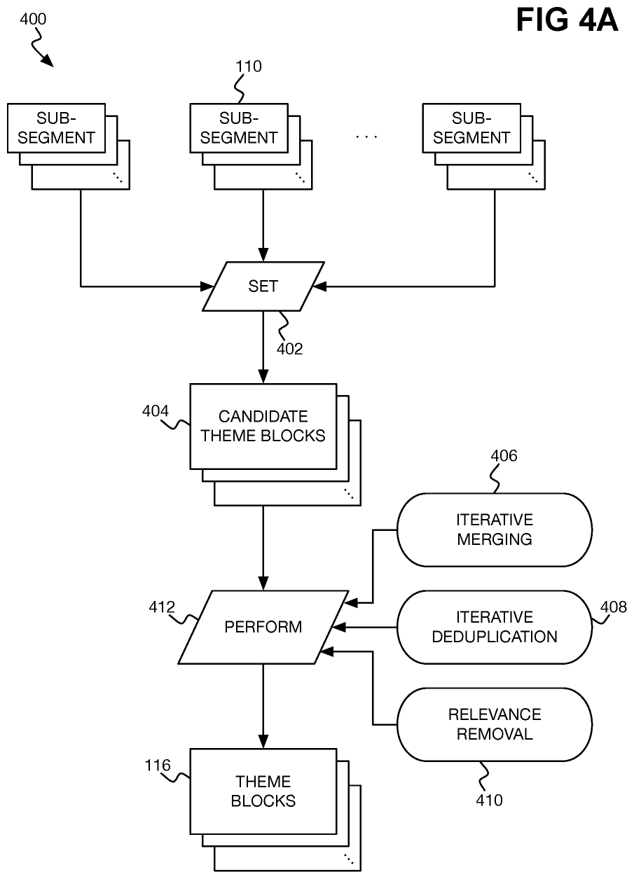

FIG. 3A shows an example process 300 for identifying a theme 112 of a video sub-segment 110. Automatic speech recognition (ASR) is applied (302) to the sub-segment 110 to generate a text transcription 304 of the speech uttered by the person speaking in the sub-segment 110. Example ASR techniques include that provided by the Google Cloud Speech-to-Text platform as described at the web site cloud.google.com/speech-to-text, the Mozilla DeepSpeech engine available at github.com/mozilla/DeepSpeech, and the Kaldi Speech Recognition toolkit available at github.com/kaldi-asr/kaldi.

Text-related sentiment analysis can be performed (306) on the text transcription 304 to generate a text-related sentiment 308 of the video sub-segment 110. Text-related sentiment analysis can be performed by applying a trained machine learning model to the text transcription 304. The machine learning model may be that provided by or that leverages Python libraries such as the Natural Language Toolkit (NLTK) library described at the web site www.nltk.org, the TextBlob library described at https://textblob.readthedocs.io/en/dev/, and/or the Valence Aware Dictionary and sEntiment Reasoner (VADER) library described at pypi.org/project/vaderSentiment/.

The text-related sentiment 308 of the video sub-segment 110 may be specified as a value between −1 and 1. A negative value connotates a negative sentiment expressed by the person speaking in the sub-segment 110, where the magnitude corresponds to how negative the sentiment is. Similarly, a positive value connotates a positive sentiment expressed by the person speaking in the sub-segment 110, where the magnitude corresponds to how positive the sentiment is. A value of 0 connotates a completely neutral sentiment expressed by the person speaking in the sub-segment 110.

In the example process 300, contextual attributes 310 of the video sub-segment 110 can also be extracted (312), and a contextual attribute-related sentiment analysis performed (314) on the extracted contextual attributes 310 to generate a contextual attribute-related sentiment 316 of the sub-segment 110. Different examples of such contextual attributes 310, and how contextual attribute-related analysis can be performed, are described later in the detailed description. Like the text-related sentiment 308, the contextual attribute-related sentiment 316 may be a value between −1 and 1.

In the depicted process 300, the text transcription 304, the text-related sentiment 308, and the contextual attribute-related sentiment 316 are input (318) into a machine learning model 320, which responsively outputs (322) the theme 112 of the sub-segment 110. The text transcription 304 is used as a feature of a feature matrix or vector input into the machine learning model 320, as is each of the sentiments 308 and 316. The machine learning model 320 may be a natural language processing (NLP) machine learning model that employs or leverages Latent Dirichlet allocation (LDA) and/or non-negative matrix factorization (NMF), for instance, as may be implemented using the PyCaret, skikit-learn, and/or Gensim Python libraries.

Instead of just considering the text transcription 304 of the speech uttered by the speaker in the video sub-segment 110 to identify the theme 112 (i.e., the topic that is being presented by the speaker), the machine learning model 320 thus also considers the text-related sentiment 308 and/or the contextual attribute-related sentiment 316. It has been novelly determined that consideration of either or both of the sentiments 308 and 316 to supplement the text transcription 304 can provide for more accurate identification of the theme 112 of a sub-segment 110, as compared to considering the text transcription 304 alone. This is a novel insight at least insofar as it is not intuitive that the sentiment 308 being conveyed by the speaker or the sentiment 316 conveyed in the contextual attributes 310 would affect identifying the topic and thus the theme 112 of the sub-segment 110.

The machine learning model 320 may consider as input features other information in addition to and/or in lieu of the text transcription 304 and/or the sentiments 308 and 316 as well. For example, the contextual attributes 310 may in one implementation be provided as an input feature to the machine learning model 320. In this case, there may be a contextual attribute feature vector corresponding to the contextual attributes on which the machine learning model 320 has been trained. For each contextual attribute, the corresponding value in the vector may be the number of times the attribute in question appears in the sub-segment 110. The number of times each contextual attribute appears in the sub-segment 110 may be normalized by the total number of times any contextual attribute appears in the sub-segment 110.

The output of the machine learning model 320—that is, the theme 112 of the sub-segment 110—may be a list of topics that the model 320 has identified in the sub-segment 110, along with a probability that each topic is the main topic, and thus the actual overarching theme 112, of the sub-segment 110. In one implementation, the machine learning model 320 may specifically provide an output topic vector having a value for each of a number of topics on which the model 320 was trained. The value for each topic is the likelihood (i.e., the probability) that the topic is the main topic of the sub-segment 110.

FIG. 3B illustratively depicts an example of one type of contextual attribute 310 that can be used in the process 300. Specifically, a sub-segment 110 may include a person 330 that is the speaker of the sub-segment 110, as well as other persons 332A, 332B, and 332C who are not speaking in the sub-segment 110, and who are collectively referred to as the persons 332. The persons 332 present in the sub-segment 110, other than the person 330 who is the speaker, are considered or constitute the contextual attributes 310 in this example. The sentiment 316 of the sub-segment 110 in this example is the collective sentiment expressed by the persons 332 per their facial expressions and/or other body language. That is, the sentiment 316 can be indicative of the reactions of the persons 332 as expressed by their facial expressions and/or other body language.

As an example implementation, an object detection technique may be applied to the video sub-segment 110 to identify the persons 330 and 332, and thus segment the persons 330 and 332 within the sub-segment 110. Example object detection techniques include those provided by the TensorFlow and PyTorch Python libraries. The person 330 who is speaking may be identified as the person who has the largest size in the sub-segment 110, or in another manner, such as by performing image processing to identify the person 330 whose lips are moving throughout the sub-segment 110.

The segmented video sub-segment 110 for each person 332 may then be subjected to a semantic segmentation technique to classify the sentiment of each person 332. Example semantic segmentation techniques include those provided by the TensorFlow and PyTorch Python libraries. The sentiment for each person 332 may be classified as a vector having a value between 0 and 1 for each of a number of different sentiments, such as happy, mad, sad, angry, and so on, indicating the likelihood that the person 332 in question is expressing the sentiment.

For each person 332, the values may be combined in a weighted manner to generate an overall sentiment for that person between −1 and 1. For example, the values for negative sentiments such as mad, sad, and angry may be weighted by a negative coefficient. The coefficient may be larger for sentiments that are considered more negative than others (e.g., anger as opposed to sadness). The values for positive sentiments such as happy may be weighted by a positive coefficient that likewise may be larger for sentiments that are considered more positive than others. To generate the actual contextual attribute-related sentiment 316 for the video sub-segment 110, the overall (weighted) sentiments of the persons 332 may be averaged.

FIG. 3C illustratively depicts an example of another type of contextual attribute 310 that can be used in the process 300. Specifically, a video sub-segment 110 may have a corresponding section of entered text 350, which can include emoji 352. For instance, persons may be able to participate in a chat session in which they provide reactions via entered text 350 and emoji 352, where a section of the chat session for the video 102 as a whole temporally corresponds to the sub-segment 110. The text 350 (not including the emoji 352) and/or the emoji 352 may be considered the contextual attributes 310 in this example.

For instance, in the case of a video conference, the participants, including the persons 330 and 332 (as well as other persons), are able to enter text 350 and emoji 352 in the chat session while the person 330 is speaking during the sub-segment 110, while the conference is being recorded as the video 102. In the case of a live presentation that is being recorded as the video 102, the persons who are able to enter text 350 and emoji 352 may not include any person 330 or 332 appearing in the video 102. In the case of an already recorded video 102, persons may be able to enter text 350 and emoji 352 when they individually or as a group watch the video 102.

The sentiment 316 of the sub-segment 110 in the example of FIG. 3C can be the collective sentiment expressed in the text 350 and/or the emoji 352 entered by such persons. That is, the sentiment 316 can be indicative of the sentiments expressed within the text 350 and/or the emoji 352 entered by the persons in reaction to the person 330 of the video sub-segment 110. In one implementation, just the text 350 not including the emoji 352 is considered, whereas in another implementation just the emoji 352 and not any other text 350 is considered. In a third implementation, both the emoji 352 and the text 350 apart from the emoji 352 are considered.

As to the text 350 not including the emoji 352, the overall sentiment 316 may be generated by performing the same text-related sentiment analysis that is performed in (306) of FIG. 3A on the text transcription 304 itself to generate the text-related sentiment 308. In this instance, the context attribute-related sentiment analysis is thus the same as the text-related sentiment analysis, but performed against different input.

As to the emoji 352 themselves, contextual attribute-related sentiment analysis can be performed by applying a machine learning model that is trained on prelabeled data (e.g., which combinations of unique emoji 352 correspond to which sentiments). Example such machine learning models that can be used include a deep learning model (such as a recurrent or a convolutional neural network), a rules-based model, or another type of model. The machine learning model may receive as input the (normalized or unnormalized) number of times each unique extracted contextual attribute 310 (i.e., emoji 352) is present in the video sub-segment 110. The machine learning model may then provide as output the contextual attribute-related sentiment 316 as a value between −1 and 1.

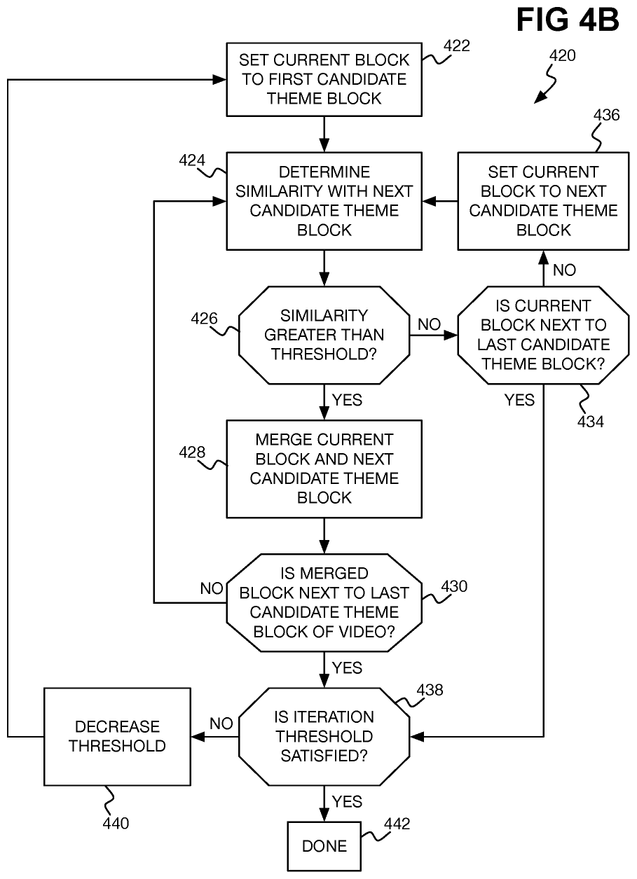

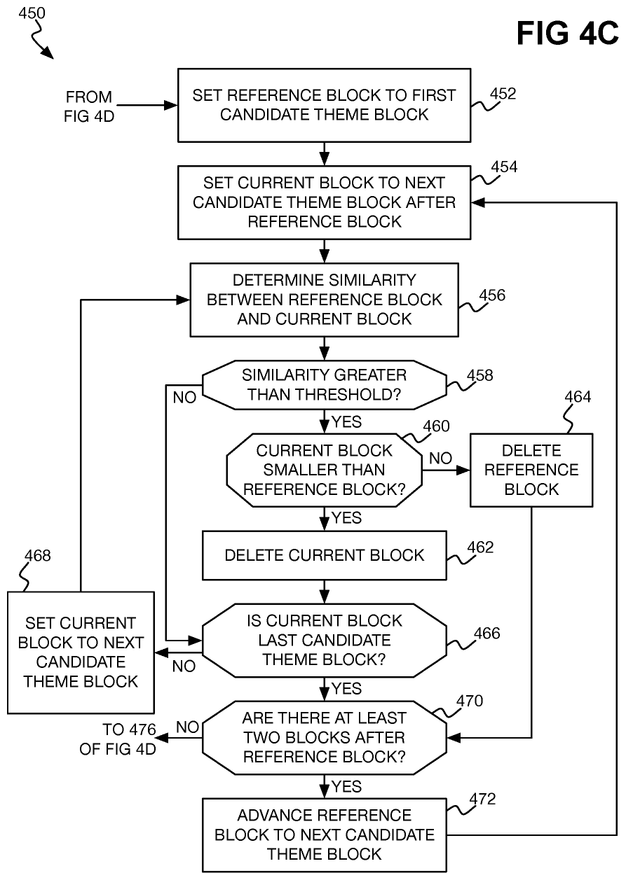

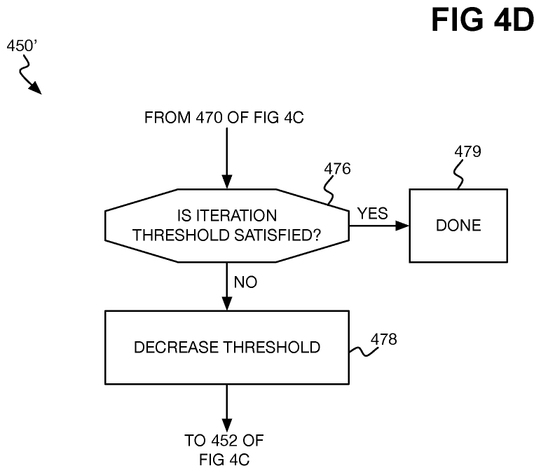

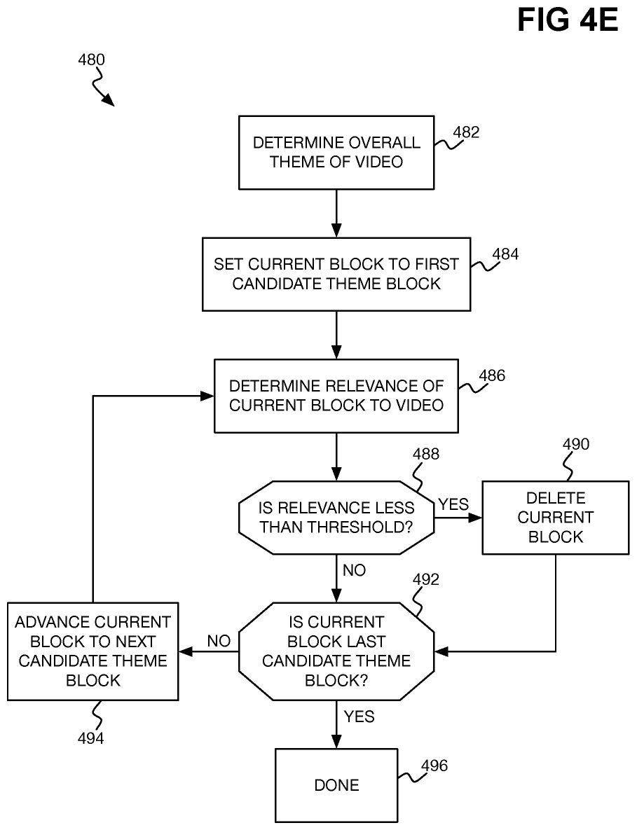

FIG. 4A shows an example process 400 for generating the theme blocks 116 of the video 102 as a whole from the sub-segments 110 once the themes 112 of the sub-segments 110 have been identified. The sub-segments 110 of the segments 106 are set (402) as candidate theme blocks 404. The candidate theme blocks 404 may be ordered in correspondence with the order of their respective sub-segments 110 within the video 102. An iterative merging process 406, an iterative deduplication process 408, and/or a relevance removal process 410 is then performed on the candidate theme blocks 404 (412), based on their respective themes 112, to yield the actual theme blocks 116 of the video 102. The processes 406, 408, and 410 may be performed in any order; as one example, the relevance removal process 410 may be performed first, followed by the iterative merging and deduplication processes 406 and 408 in that order. Furthermore, the processes 406, 408, and 410 can be performed in such a way that they are reversible.

The candidate theme blocks 404 that remain after the processes 406, 408, and 410 have been performed constitute the theme blocks 116 of the video 102, where each theme block 116 ultimately includes one or more contiguous sub-segments 110 that have a common theme. The theme of a theme block 116 is based on the themes 112 of its constituent sub-segments 110. As noted above, the theme 112 of a sub-segment 110 can be a vector of values for corresponding topics, where each value is the probability or likelihood that the corresponding topic is the main topic. In this case, the theme of a theme block 116 can similarly be a vector of values for corresponding topics, where the value for a given topic is a weighted combination of the values for this topic in the vectors of the constituent sub-segments 110. The values may be weighted based on the length (e.g., size) of their sub-segments 110.

As a concrete example, a theme block 116 may include two sub-segments 110A and 110B. The sub-segment 110A may have a vector (a1, a2), where a1 is the probability that the sub-segment 110A has topic 1 as its theme 112, and a2 is the probability that the sub-segment 110A has topic 2 as its theme 112. The sub-agent 110B may similarly have a vector (b1, b2). The sub-segment 110A may be A seconds in length and the sub-segment 110B may be B seconds in length. Therefore, the theme of the theme block 116 in question is expressed by the vector ((A/A+B a1)+(B/A+B b1),(A/A+B a2)+(B/A+B b2)). In one implementation, the theme of the theme block 116 may be simplified to the topic having the largest value in this vector.

FIG. 4B shows a flowchart of an example method 420 to realize the iterative merging process 406. In general, the iterative merging process 406 merges candidate theme blocks 404 that are similar to one another over a number of iterations. The method 420 includes setting a current block to the first candidate theme block 404 (422). The similarity between the current block and the next candidate theme block 404 (i.e., the block 404 following the current block) is determined (424). In one implementation, the similarity may be determined as a Jaccard or cosine similarity between the text transcription 304 of the current block and the text transcription 304 of the next candidate theme block 404.

In another implementation, the similarity may be determined based on the vector distance, such as the Euclidean distance, between the theme 112 of the current block and the theme 112 of the next candidate theme block 404, in the case in which each theme 112 is a vector as noted above. The vector distance may then be normalized to a value between 0 and 1. The similarity may then be 1 minus the normalized vector distance, to yield a similarity value that increases with increasing similarity.

If the similarity is greater than a similarity threshold (426), then the current block is merged with the next candidate theme block 404 (428), such that the current block and the next candidate theme block 404 are replaced with a merged candidate theme block 404. The themes 112 of the current block and the next candidate theme block 404 are similarly merged to generate the theme 112 for the merged candidate theme block 404. In the case in which the theme 112 is a vector, the vectors for the current block and the next candidate theme block 404 may be combined as has been described above in relation to FIG. 4A. The merged block is now the current theme block.

If the merged candidate theme block 404 is not the next to the last candidate theme block 404 (430), then the process 400 is repeated at (424). For example, there may be four candidate theme blocks A, B, C, and D. If block A is the current block, and if block A is merged with block B to yield the merged block AB, then there are now three candidate theme blocks AB, C, and D. The block AB is not the next to last candidate theme block, and therefore the process is repeated at (424) to compare the block AB with the block C.

If the similarity is not greater than the similarity threshold (426), however, and if the current block is not the next to last candidate theme block 404 (434), then the current block is set to the next candidate theme block 404 (436), and the process 400 is similarly repeated at (424). For example, there may be four candidate theme blocks A, B, C, and D. If block C is the current block, and is not merged with block D, then the process 400 does not advance to (436), because block C is the next to last block.

Once the process 400 reaches (438), whether an iteration threshold has been satisfied is determined. The iteration threshold may be that a number of iterations of the process 400 beginning at (422) have been performed. The iteration threshold may instead be that the number of candidate theme blocks 404 be no greater than a specified maximum number, or that each candidate theme block 404 have at least a specified minimum length. If the iteration threshold has not been satisfied, then the similarity threshold used in (426) is decreased (440), and another iteration of the method 420 begins at (422). Once the iteration threshold has been satisfied, the method 420 is finished (442).

FIGS. 4C and 4D show a flowchart of an example method 450/450′ to realize the iterative deduplication process 408. In general, the iterative deduplication process 408 removes candidate theme blocks 404 that are duplicative of another candidate theme block 404. For example, if three candidate theme blocks 404 are similar to one another, two of the three can be removed. The deduplication process 408 may be performed after the merging process 406 so that the candidate theme blocks 404 that no two blocks 404 that are sufficiently similar to one another to be considered duplicative are not contiguous with one another. This is because if the blocks were contiguous they would have been merged in the process 406.

Referring first to FIG. 4C, the method 450/450′ begins with setting a reference block to the first candidate theme block 404 (452). A current block is then set to the next candidate theme block 404 immediately after the reference block (454). The similarity between the reference block and the current block is determined (456), as has been described in relation to FIG. 4B.

If the similarity is greater than a similarity threshold (which may be the same similarity threshold used in FIG. 4B), and if the current block is smaller than the reference block (460), then the current block is deleted or removed (462), and thus is no longer a candidate theme block 404. However, if the reference block is smaller than the current block (460), then the reference block is deleted or removed (464), and thus is no longer a candidate theme block 404. That is, the smaller of the two blocks is removed.

In the case in which the current block is deleted, the method 450/450′ proceeds from (462) to (466), to which the method 450/450′ also proceeds if the similarity between the current block and the reference block is not greater than the similarity threshold (458). As such, if the current block (which may have been deleted) is not the last candidate theme block 404 (466), then the current block is advanced to the next candidate theme block 404 (468), and the method 450 is repeated at (456). If the current block is the last candidate theme block 404 (466), however, then the method 450/450′ proceeds (470), to which the method 450/450′ also proceeds from (464) in the case in which the reference block is deleted. If there are at least two candidate theme blocks 404 after the reference block (which may have been deleted), then the reference block is advanced to the next candidate theme block 404 (472), and the method 450/450′ is repeated at (454).

For example, if there are candidate blocks A, B, C, and D, and the reference block is set to A, then the current block is first set to B. Assume that A and B are sufficiently similar, and that B is smaller than A. Therefore, B is deleted, and the current block is advanced from B to C. Then, if A and C are not sufficiently similar, the current block is advanced from C to D. If A and D are not sufficiently similar, the reference block is advanced A to C (since B has been deleted, there are at least two blocks after A—the blocks C and D), and the current block is set to D. Assuming that C and D are similarity similar, and that C is smaller than D, C is deleted. The process of FIG. 4C is then finished, since there are not at least two blocks after C. Once there are not at least two candidate theme blocks 404 after the reference block, therefore, the method 450/450′ proceeds from (470) of FIG. 4C to (476) of FIG. 4D.

Referring to FIG. 4D, whether an iteration threshold has been satisfied is determined. The iteration threshold may be the same as that described in relation to FIG. 4B. If the iteration threshold has not been satisfied (476), then the similarity threshold used in (458) is decreased (478), and another iteration of the method 450/450′ begins at (452) of FIG. 4C. Once the iteration threshold has been satisfied, the method 450/450′ is finished (479).

FIG. 4E shows a flowchart of an example method 480 to realize the relevance removal process 410. In general, the relevance removal process 410 removes candidate theme blocks 404 that have least relevance to the video 102 as a whole. The method 480 may in one implementation begin by determining a preliminary overall theme of the video 102 (482). For example, the vectors of all the candidate theme blocks 404 may be combined as has been described above in relation to FIG. 4A in order to generate a vector constituting the preliminary overall theme of the video 102. A current block is then set to the first candidate theme block 404 (484).

The relevance of the current block to the video 102 as a whole is determined (486). In one implementation, the relevance may be the Jaccard or cosine similarity between the text transcription 304 of the current block and the text transcription to the entire video 102 (which includes the text transcriptions 304 of all the sub-segments 110). In another implementation, the relevance may be the similarity between the theme of the current block and the preliminary overall theme of the video 102. In this case, the relevance may be calculated as 1 minus the normalized vector distance between the vector that is the theme 112 of the current block and the vector that is the overall preliminary theme of the video 102.

If the relevance is lower than a relevance threshold (488), then the current block is deleted (490). If the current block is not the last candidate theme block 404 (492), then the current block is advanced to the next candidate theme block 404 (494), and the method 480 is repeated at (486). Once all the candidate theme blocks 404 have been examined for relevance to the video 102 as a whole, the method 480 is finished (496).

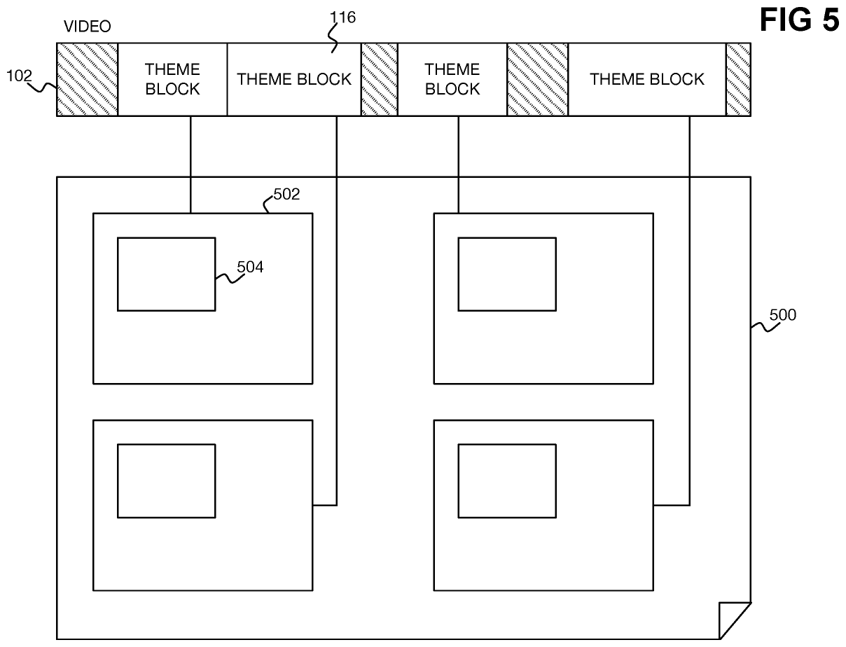

FIG. 5 shows an example summarization 500 of a video 102, including individual summarizations 502 of the theme blocks 116 of the video 102. In the example, there are four theme blocks 116. Portions of the video that are not included in any theme block 116 are identified by shading. In the example, the first two theme blocks 116 are contiguous to one another, whereas the third and fourth theme blocks 116 are discontiguous to each other and to the first two theme blocks 116.

In the example, the summarization 500 is a non-video summarization in the form of one or more printed pages. Each printed page may include a maximum of Y summarizations 502 (where Y equals four in the example), which are ordered on the page in correspondence with the order of appearance of the theme blocks 116 within the video 102. In the example, the summarizations 502 are equal in size, but in another implementation, they may have different sizes.

The summarization 502 of each theme block 116 can include a representative frame 504 for that theme block 116, which may be selected using a particular technique or simply set to the first frame, last frame, or a random frame of the theme block 116. A summarization 502 can include other information regarding its corresponding theme block 116 as well. For example, a summarization 502 can include a summary of the text transcription of the theme block 116, the theme of the theme block 116 (such as the main topic of the theme block 116 or each topic having a probability that it is the main topic greater than a threshold), and so on.

In one implementation, a summarization 500 of a video 102 may be generated by first selecting a page template as to how summarizations 502 of the theme blocks 116 of the video 102 are to appear on each page. A number of pages is instantiated to accommodate the number of theme blocks 116. The summarizations 502 of the theme blocks 116 are generated, and then populated on the instantiated page or pages in order.

Other techniques can also be used to generate the summarization 500. For example, machine learning techniques may be employed to select an appropriate page template or templates, where different pages may employ different templates. The space afforded to summarizations 502 may differ in size on a given page. For example, a theme block 116 may be identified as the most important or most relevant theme block 116 within the video 102, such that its summarization 502 is afforded the most prominent position and/or the most space on the first page.

The process 100 for generating theme blocks 116 for a video 102 that has been described does not simply automate manual user selection of the theme blocks 116 for the video 102. If a user were to manually select the theme blocks 116, they would not perform the process 100 of FIG. 1 per the implementation of FIGS. 2A-2B, 3A-3B, and/or 4A-4C. Furthermore, the process 100 is an image processing technique, and thus is an improvement of image processing technology.

Generating a summarization 500 of a video 500 can further be considered a digital content generation process, which is also a technology that is therefore improved via using the process 100 to identify the theme blocks 116. The process 100 does not generate the theme blocks 116 of a video 102 for this sake alone, in other words, but rather as part of a content generation process that uses the theme blocks 116 in the generation of a non-video summarization of the overall video 102.

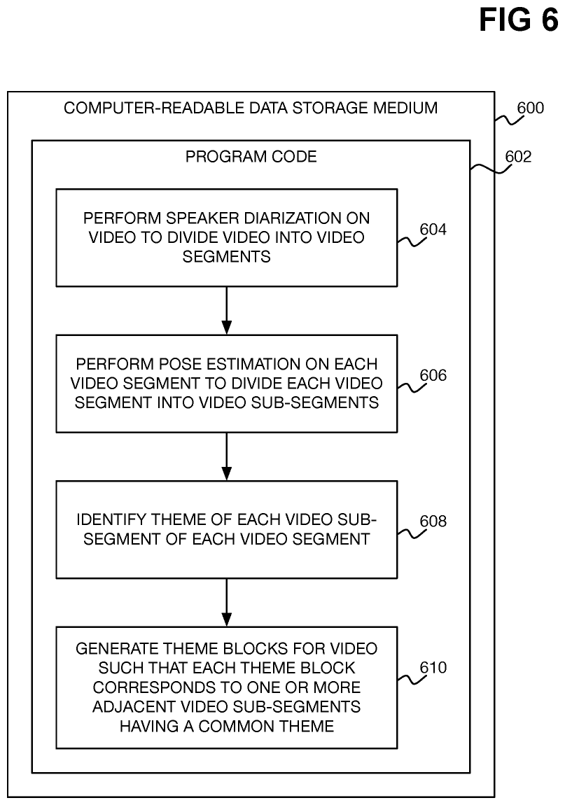

FIG. 6 shows an example non-transitory computer-readable data storage medium 600 storing program code 602 (e.g., instructions) executable by a processor to perform processing. The processing includes performing speaker diarization on a video 102 to divide the video 102 into video segments 106 such that each video segment 106 has a different speaker as compared to any adjacent video segment 106 (604). The processing includes performing pose estimation on each video segment 106 to divide each video segment 106 into one or more video sub-segments 110 such that each video sub-segment 110 has a different speaker pose as compared to any adjacent video sub-segment 110 of the same video segment 106 (606). The processing includes identifying a theme 112 of each video sub-segment 110 of each video segment 106 using machine learning (608), and generating theme blocks 116 for the video 102 such that each theme block 116 corresponds to one or more of the video sub-segments 110 having a common theme (610).

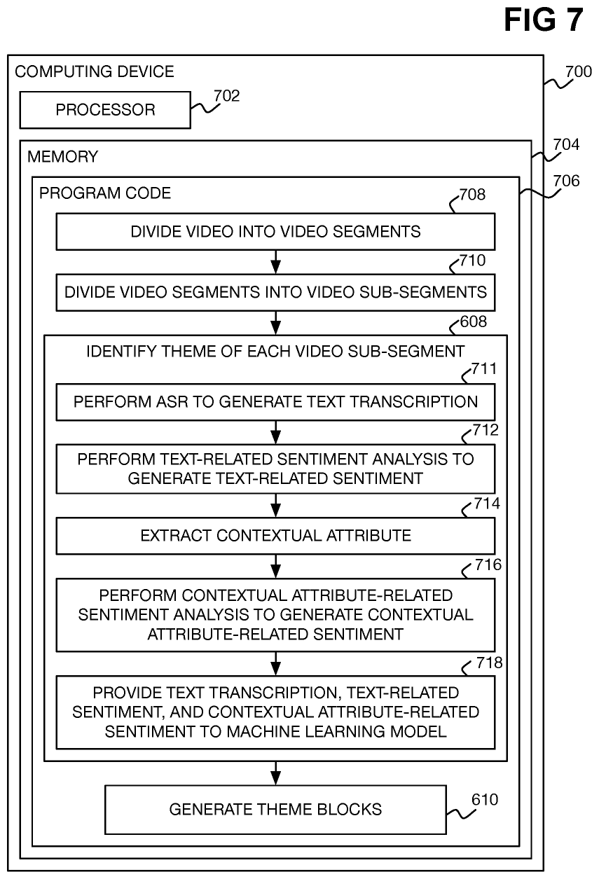

FIG. 7 shows an example computing device 700 having a processor 702 and a memory 704 storing program code 706 (e.g., instructions) executable by the processor to perform processing. The processing includes dividing a video 102 into video segments 106 (708), and dividing each video segment 106 into one or more video sub-segments 110 (710), which can be respectively realized by (604) and (606) of FIG. 6. The processing includes identifying a theme 112 of each video sub-segment 110 using machine learning (608), and generating theme blocks 116 for the video 102 such that each theme block 116 corresponds to one or more of the video sub-segments 110 having a common theme (610).

In FIG. 7, to identify the theme of each video sub-segment 110 in (608), the processing includes the following. Automatic speech recognition is performed on a video sub-segment 110 to generate a text transcription 304 of the video sub-segment 110 (711). Text-related sentiment analysis can then be performed on the text transcription 304 to generate a text-related sentiment 308 (712).

Furthermore, contextual attributes 310 regarding the video sub-segment 110 can be extracted (714). Contextual attribute-related sentiment analysis can then be performed on the contextual attributes 310 to generate a contextual attribute-related sentiment 316 (716). The text transcription 304, the text-related sentiment 308, and the contextual attribute-related sentiment 316 can therefore be provided as input to a machine learning model 320 to receive as output the theme 112 of the video sub-segment 110 (718).

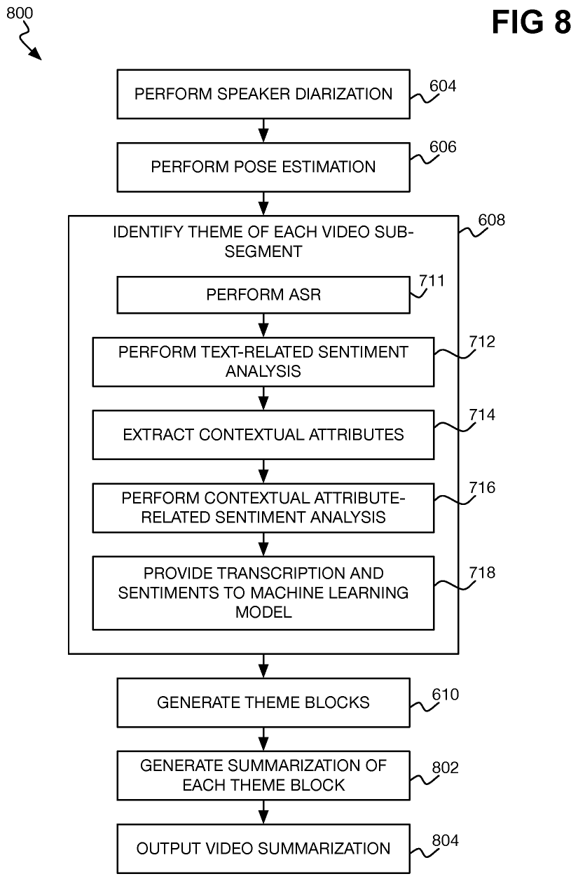

FIG. 8 shows an example method 800, which may be implemented as program code stored on a memory or other non-transitory computer-readable data storage medium and that is executable by a processor to perform the method 800. The method 800 includes performing speaker diarization on a video 102 to divide the video 102 into video segments 106 (604), and performing pose estimation on each video segment 106 to divide each video segment 106 into one or more video sub-segments 110 (606). The method 800 includes identifying a theme 112 of each video sub-segment 110 of each video segment 106 using machine learning (608).

The theme 112 of each video sub-segment 110 may be identified as follows. Automatic speech recognition can be performed to generate a text transcription 304 (711), and text-related sentiment analysis can be performed to generate a text-related sentiment 308 (712). Contextual attributes 310 can be extracted (714), and contextual attribute-related sentiment analysis can be performed to generate a contextual attribute-related sentiment 316 (716). The text transcription 304 and the sentiments 308 and 316 can then be provided as input to a machine learning model 320 to receive as output the theme 112 (718).

The method 800 includes generating theme blocks 116 for the video 102 such that each theme block 116 corresponds to one or more of the video sub-segments 110 having a common theme (610). The method 800 can include generating a summarization 502 of each theme block 116 (802), and outputting a summarization 500 of the video 102 that includes the summarization 502 of each theme block 116 (804), such as by printing if the summarization 502 is a non-video summarization.

Techniques have been described for generating theme blocks 116 for a video 102. The generation process can be performed without user interaction, and leverages machine learning to provide a technological improvement in such theme block generation as an image processing technique. The generation process is performed in such a way that cannot be tractably performed manually by a user, and indeed in such a way that would not be performed if a user were to manually generate the theme blocks 116. The automatic nature of the process improves generation speed by employing machine learning and other image processing techniques, and moreover the described techniques have been found to result in generation of theme blocks 116 that accurately represent the video 102.

We claim:

1. A non-transitory computer-readable data storage medium storing program code executable by a processor to perform processing comprising:
performing speaker diarization on a video to divide the video into video segments such that each video segment has a different speaker as compared to any adjacent video segment;
performing pose estimation on each video segment to divide each video segment into one or more video sub-segments such that each video sub-segment has a different speaker pose as compared to any adjacent video sub-segment of a same video segment;
identifying a theme of each video sub-segment of each video segment using machine learning; and
generating a plurality of theme blocks for the video such that each theme block corresponds to one or more of the video sub-segments having a common theme.

2. The non-transitory computer-readable data storage medium of claim 1, wherein the processing further comprises:
generating a summarization of each theme block of the video; and
outputting a summarization of the video, the summarization of the video including the summarization of theme block.

3. The non-transitory computer-readable data storage medium of claim 1, wherein identifying the theme of each video sub-segment comprises, for each video sub-segment:
performing automatic speech recognition on the video sub-segment to generate a text transcription of the video sub-segment;
performing sentiment analysis on the text transcription of the video sub-segment to generate a sentiment of the video sub-segment; and
providing the text transcription of the video sub-segment and the sentiment of the video sub-segment as input to a machine learning model to receive as output the theme of the video sub-segment.

4. The non-transitory computer-readable data storage medium of claim 1, wherein identifying the theme of each video sub-segment comprises, for each video sub-segment:
extracting contextual attributes regarding the video sub-segment;
performing sentiment analysis on the contextual attributes regarding the video sub-segment to generate a sentiment of the video sub-segment;
performing automatic speech recognition on the video sub-segment to generate a text transcription of the video sub-segment; and
providing the text transcription of the video sub-segment and the sentiment of the video segment as input to a machine learning model to receive as output the theme of the video segment.

5. The non-transitory computer-readable data storage medium of claim 4, wherein extracting the contextual attributes regarding the video sub-segment comprises:
performing object detection on the video sub-segment to identify persons within the video sub-segment other than a speaker of the video sub-segment,
wherein the persons within the video sub-segment other than the speaker constitute at least some of the contextual attributes regarding the video sub-segment,
and wherein the sentiment of the video sub-segment is indicative of reactions of the persons within the video sub-segment.

6. The non-transitory computer-readable data storage medium of claim 4, extracting the contextual attributes regarding the video sub-segment comprises:
extracting text entered by persons in reaction to a speaker of the video sub-segment,
wherein the text entered by the persons in reaction to the speaker of the video sub-segment constitute at least some of the contextual attributes regarding the video sub-segment,
and wherein the sentiment of the video sub-segment is indicative of sentiments expressed within the text entered by the persons in reaction to the speaker of the video sub-segment.

7. The non-transitory computer-readable data storage medium of claim 4, extracting the contextual attributes regarding the video sub-segment comprises:
extracting emojis entered by persons in reaction to a speaker of the video sub-segment,
wherein the emojis entered by the persons in reaction to the speaker of the video sub-segment constitute at least some of the contextual attributes regarding the video sub-segment,
and wherein the sentiment of the video sub-segment is indicative of sentiments corresponding to the emojis entered by the persons in reaction to the speaker of the video sub-segment.

8. The non-transitory computer-readable data storage medium of claim 1, wherein generating the theme blocks for the video comprises:
setting the video sub-segments of the video segments as a plurality of candidate theme blocks, such that each candidate theme block corresponds to a different video sub-segment; and
performing, on the candidate theme blocks, any combination of:
an iterative merging process to iteratively merge adjacent candidate theme blocks having similar themes;
an iterative deduplication process to iteratively deduplicate nonadjacent candidate theme blocks having similar themes; and
a removal process to remove each candidate theme block for which the theme has a relevance to the video lower than a threshold;
wherein the candidate theme blocks after the any combination of the iterative merging process, the iterative deduplication process, and the removal process has been performed are specified as the theme blocks for the video.

9. A computing device comprising:
a processor; and
a memory storing instructions executable by the processor to:
divide a video into video segments;
divide each video segment into one or more video sub-segments;
identify a theme of each video sub-segment using machine learning; and
generate a plurality of theme blocks for the video such that each theme block corresponds to one or more of the video sub-segments having a common theme,
wherein the instructions are executable by the processor to identify the theme of each video sub-segment by, for each video sub-segment:
performing automatic speech recognition on the video sub-segment to generate a text transcription of the video sub-segment;
performing text-related sentiment analysis on the text transcription of the video sub-segment to generate a text-related sentiment of the video sub-segment;
extracting contextual attributes regarding the video sub-segment;
performing contextual attribute-related sentiment analysis on the contextual attributes of the video sub-segment to generate a contextual attribute-related sentiment of the video sub-segment; and
providing the text transcription, the text-related sentiment, and the contextual attribute-related sentiment of the video sub-segment as input to a machine learning model to receive as output the theme of the video sub-segment.

10. The computing device of claim 9, wherein the instructions are executable by the processor to further:
generate a summarization of each theme block of the video; and
output a summarization of the video, the summarization of the video including the summarization of theme block.

11. The computing device of claim 9, wherein the instructions are executable by the processor to divide the video into the video segments by performing speaker diarization on the video, such that each video segment has a different speaker as compared to any adjacent video segment.

12. The computing device of claim 9, wherein the instructions are executable by the processor to divide each video segment into the one or more video segments by performing pose estimation on the video segment, such that the each video sub-segment has a different speaker pose as compared to any adjacent video sub-segment of the video segment.

13. The computing device of claim 9, wherein extracting the contextual attributes regarding the video sub-segment comprises:
performing object detection on the video sub-segment to identify persons within the video sub-segment other than a speaker of the video sub-segment,
wherein the persons within the video sub-segment other than the speaker constitute at least some of the contextual attributes regarding the video sub-segment,
and wherein the sentiment of the video sub-segment is indicative of reactions of the persons within the video sub-segment.

14. The computing device of claim 9, wherein extracting the contextual attributes regarding the video sub-segment comprises:
extracting text entered by persons in reaction to a speaker of the video sub-segment,
wherein the text entered by the persons in reaction to the speaker of the video sub-segment constitute at least some of the contextual attributes regarding the video sub-segment,
and wherein the sentiment of the video sub-segment is indicative of sentiments expressed within the text entered by the persons in reaction to the speaker of the video sub-segment.

15. The computing device of claim 9, wherein extracting the contextual attributes regarding the video sub-segment comprises:
extracting emojis entered by persons in reaction to a speaker of the video sub-segment,
wherein the emojis entered by the persons in reaction to the speaker of the video sub-segment constitute at least some of the contextual attributes regarding the video sub-segment,
and wherein the sentiment of the video sub-segment is indicative of sentiments corresponding to the emojis entered by the persons in reaction to the speaker of the video sub-segment.

16. The computing device of claim 9, wherein the instructions are executable by the processor to generate the theme blocks for the video by:
setting the video sub-segments of the video segments as a plurality of candidate theme blocks, such that each candidate theme block corresponds to a different video sub-segment; and
performing, on the candidate theme blocks, any combination of:
an iterative merging process to iteratively merge adjacent candidate theme blocks having similar themes;
an iterative deduplication process to iteratively deduplicate nonadjacent candidate theme blocks having similar themes; and
a removal process to remove each candidate theme block for which the theme has a relevance to the video lower than a threshold;
wherein at least some of the candidate theme blocks after the any combination of the iterative merging process, the iterative deduplication process, and the removal process has been performed are specified as the theme blocks for the video.

17. A method comprising:
performing, by a processor, speaker diarization on a video to divide the video into video segments such that each video segment has a different speaker as compared to any adjacent video segment;
performing, by the processor, pose estimation on each video segment to divide each video segment into one or more video sub-segments such that each video sub-segment has a different speaker pose as compared to any adjacent video sub-segment of a same video segment;
identifying, by the processor, a theme of each video sub-segment of each video segment using machine learning by, for each video sub-segment:
performing automatic speech recognition on the video sub-segment to generate a text transcription of the video segment;
performing text-related sentiment analysis on the text transcription of the video sub-segment to generate a text-related sentiment of the video sub-segment;
extracting contextual attributes regarding the video sub-segment;
performing contextual attribute-related sentiment analysis on the contextual attributes of the video sub-segment to generate a contextual attribute-related sentiment of the video sub-segment; and
providing the text transcription, the text-related sentiment, and the contextual attribute-related sentiment of the video sub-segment as input to a machine learning model to receive as output the theme of the video sub-segment;
generating, by a processor, a plurality of theme blocks for the video such that each theme block corresponds to one or more of the video sub-segments having a common theme;
generating, by the processor, a summarization of each theme block of the video; and
outputting, by the processor, a summarization of the video, the summarization of the video including the summarization of each theme block.

18. The method of claim 17, wherein generating the theme blocks for the video comprises:
setting the video sub-segments of the video segments as a plurality of candidate theme blocks, such that each candidate theme block corresponds to a different video sub-segment; and
performing an iterative merging process on the candidate theme blocks to iteratively merge adjacent candidate theme blocks having similar themes,
wherein at least some of the candidate theme blocks after the iterative merging process has been performed are specified as the theme blocks for the video.

19. The method of claim 17, wherein generating the theme blocks for the video comprises:
setting the video sub-segments of the video segments as a plurality of candidate theme blocks, such that each candidate theme block corresponds to a different video sub-segment; and
performing an iterative deduplication process on the candidate theme blocks to iteratively deduplicate nonadjacent candidate theme blocks having similar themes,
wherein at least some of the candidate theme blocks after the iterative deduplication process has been performed are specified as the theme blocks for the video.

20. The method of claim 17, wherein generating the theme blocks for the video comprises:
setting the video sub-segments of the video segments as a plurality of candidate theme blocks, such that each candidate theme block corresponds to a different video sub-segment; and
performing a removal process on the candidate theme blocks to remove each candidate theme block for which the theme has a relevance to the video lower than a threshold,
wherein at least some of the candidate theme blocks after the removal process has been performed are specified as the theme blocks for the video.
